(19) United States
(12) Patent Application Publication
(10) Pub. No.: US 2009/0287570 A1
(43) Pub. Date: Nov. 19, 2009

(54) E-commerce website

(76) Inventors: Glenn D. Adamousky, Edison, NJ (US); Gordon T. Graves, Austin, TX (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/153,168

(22) Filed: May 14, 2008

(51) Int. Cl. A63F 9/24; G06F 19/00; G06Q 30/00

(52) U.S. Cl. 705/14.54; 463/17; 463/42; 705/26; 705/14.12

(57) ABSTRACT

An Internet e-commerce website provides online content having incentives that motivate consumers to select affiliated vendors. After purchasing goods or services from the affiliated vendors, consumers view a purchase history and receive credit based on purchase amounts. Credits may be used to enter a sweepstakes. Consumers are also provided access to local vendors via website links to the local vendors' web pages. After completing their purchases, consumers receive scratch cards from the vendor. A consumer logs back onto the e-commerce website, and enters a promotion identifying number from the scratch card. A consumer's account is credited based on purchases made. The consumer uses the credits to enter a sweepstakes or other games offered through the website. The sweepstakes is a lottery-style play wherein the consumer picks a desired set of digits using a lottery play slip. The available numbers may correspond to a scheduled state drawing to ensure integrity.

### BACKGROUND OF THE INVENTION

1. Field of the Invention

The present invention relates generally to e-commerce, and more particularly to an e-commerce website wherein visitors to the site are provided incentives to visit websites of participating merchants.

2. Description of the Related Art

A wide range of e-commerce systems with rewards and incentives have been established and used in retail stores, sales outlets, on line virtual stores, and the like. However, the problem remains that consumers are bombarded with promotional reward systems that do not capture their attention for very long. It would be desirable to provide an incentive to consumers that captures their attention over a sustained period of time, measured in weeks, months, and even years. Such consumer loyalty is coveted by merchants throughout the “brick and mortar” as well as virtual on-line world of commerce.

Thus, an e-commerce website solving the aforementioned problems is desired.

### SUMMARY OF THE INVENTION

The e-commerce website provides online content having incentives that motivate consumers to select affiliated vendors. More specifically, this invention provides linked rewards to site visitors wherein the site visitors may purchase goods and services online through the website, a telephone network or a Wi-Fi network, or at participating local merchants' “Brick and Mortar locations”, which allow them to earn rewards points or credits. After making purchases, customers may view their purchase history and receive credit based on purchase amounts. Credits may be used to enter a sweepstakes or other games involving an element of chance. Visitors to the website who prefer to conduct business at a local vendor can access the website to click a link to the local vendor's web page.

After completing their purchases at the “Brick and Mortar” location consumers receive scratch cards from the vendor. A consumer who logs back onto the e-commerce website enters a number revealed by scratching off the card. Additionally, the consumer's account is credited, based on the purchases made. The consumer may then use these credits to enter a game of chance, such as a sweepstakes. The sweepstakes operates in a lottery-style play, wherein the consumer picks a desired set of digits using a lottery play slip. The available numbers may correspond to a scheduled state drawing to ensure integrity. The aforementioned exemplary game provides a method of promoting product brands and customer loyalty to retail stores, wholesale stores, store chains, and the like.

These and other features of the present invention will become readily apparent upon further review of the following specification and drawings.

### BRIEF DESCRIPTION OF THE DRAWINGS

FIG. 1 is a diagrammatic system view of an e-commerce website according to the present invention.

FIG. 2 is a simulated screen shot of the Online Vendors in an e-commerce website according to the present invention.

FIG. 3 is a simulated screenshot of the game selection page in an e-commerce website according to the present invention.

FIG. 4 is a simulated screenshot of an online play slip in an e-commerce website according to the present invention.

FIG. 5 is a simulated screenshot of a sign up form in an e-commerce website according to the present invention.

Similar reference characters denote corresponding features consistently throughout the attached drawings.

### DETAILED DESCRIPTION OF THE PREFERRED EMBODIMENT

The e-commerce website provides online accounts from which vendors can be chosen by consumers. After making purchases at affiliated merchant establishments (virtual or “brick and mortar”), customers may view a history of their purchases and receive credit based on purchase amounts. Credits are stored electronically and may be used to enter a sweepstakes or other game. Consumers who prefer to make purchases at a local vendor can access the website to click a link to the local vendor's web page. After completing their purchases, consumers receive scratch cards from the vendor.

A consumer who logs back onto the e-commerce website enters a promotion identifying number revealed by scratching off the card. Additionally, the consumer's account is credited based on the purchases made. The consumer may then use these credits to enter e.g., a sweepstakes. The sweepstakes operates in a lottery style play wherein the consumer picks (or has the system pick) a set of digits using a lottery play slip. The available numbers may correspond to a scheduled state drawing to ensure integrity.

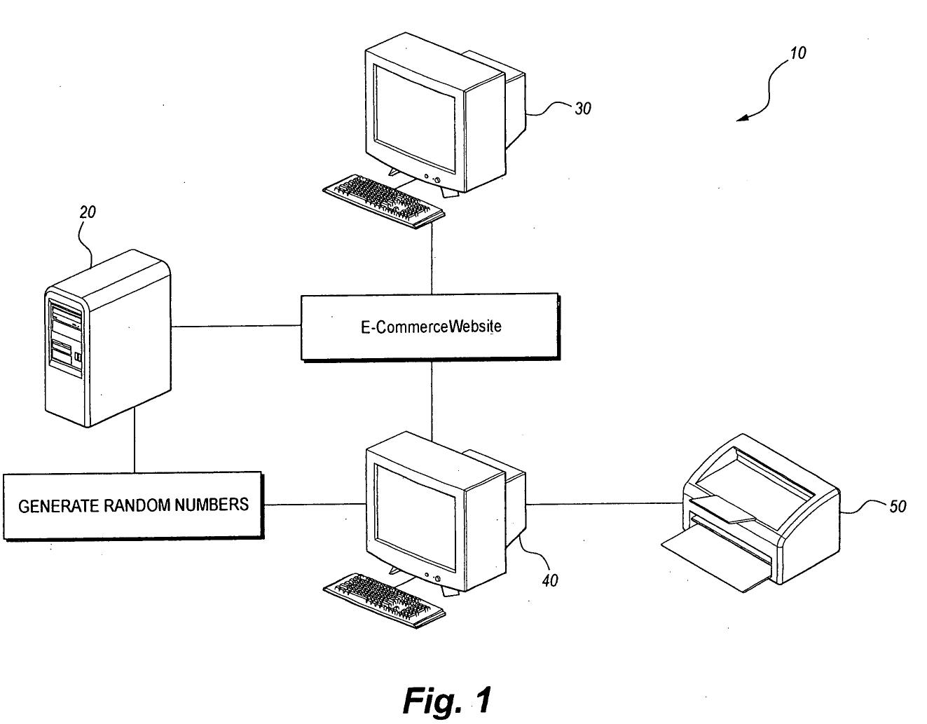

As shown in FIGS. 1-5, within the system 10, a personal computing system 30 may be connected via the Internet or any other network to a game control server running on a host computer 20 to provide the consumer with the capability to access the inventive e-commerce website. Host computer 20 may include a database, the database storing awards information, affiliated merchant information, random numbers and other game information, consumer information, such as user picks and credits, and the like. Alternatively, the database may be externally accessible to host computer 20.

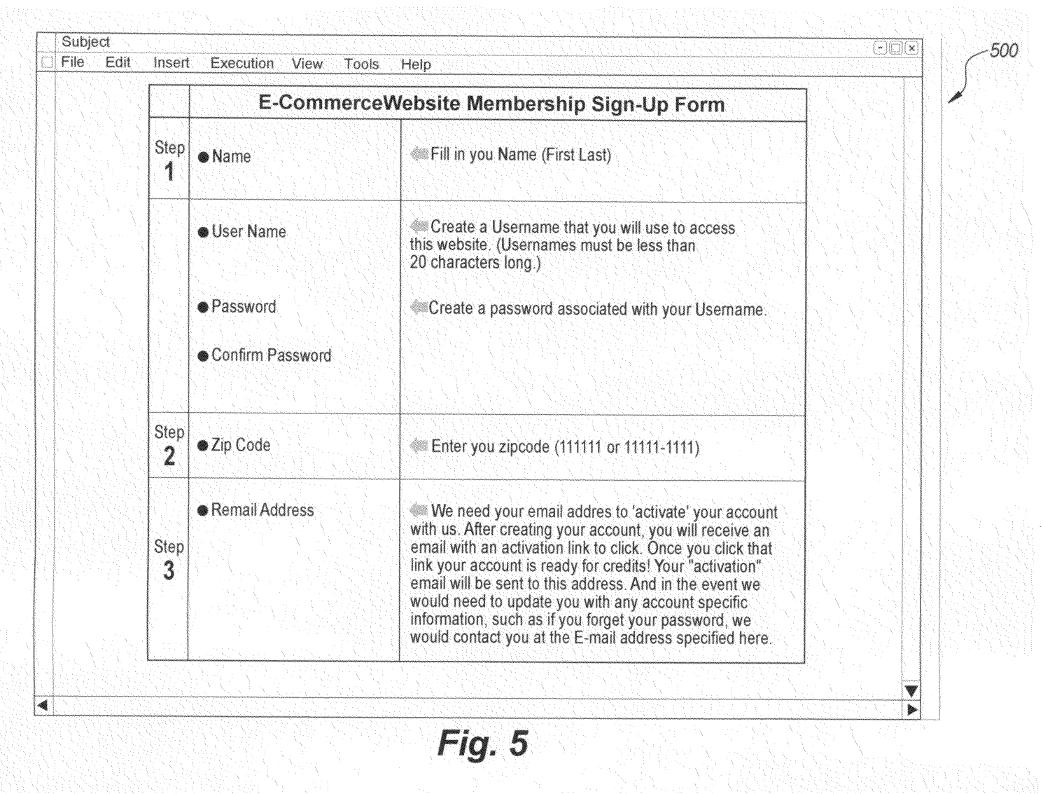

The system is preferably implemented as an e-commerce website that provides incentives for visitors to click through to affiliate merchants' websites over the Internet. It should be understood that persons having ordinary skill in the art are well aware of a variety of technologies and methodologies that can be used to implement interconnection of game control server running on host computer 20 to a consumer's computer 30 via the Internet or any other network thereby enabling consumer access to merchant websites via links accessible from host 20 of the game control server. The system 10 accepts, and preferably requires the consumer to enter personal identification information. As shown in FIG. 5, an electronic form 500 may be provided for the consumer's entry of the personal identification information. Preferably the system issues the consumer membership for access to the website at no charge to the consumer. The system 10 may also issue to the consumer a free gaming credit upon registration.

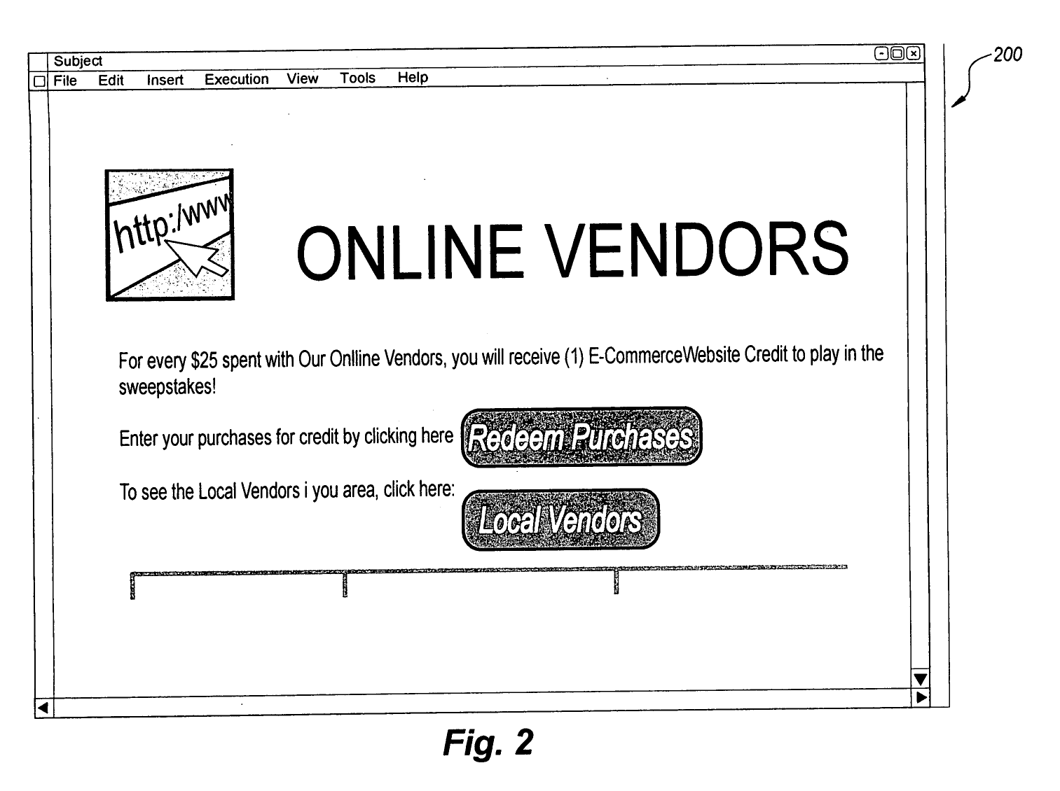

As shown in FIG. 2, the system 10 provides at least one web page displaying a list of participating merchants 200. Links to the participating merchants are provided from which the consumer can select for a shopping experience. In the event of a virtual shopping experience, clicking on a selected merchant icon takes the consumer to the selected merchant's website where the consumer can complete his/her shopping by making a purchase. After finishing purchases from the selected merchant, the consumer is returned to a personal account page that verifies and approves the items purchased by the consumer. The consumer's credit awards are subsequently updated as a function of the amount spent with the selected merchant.

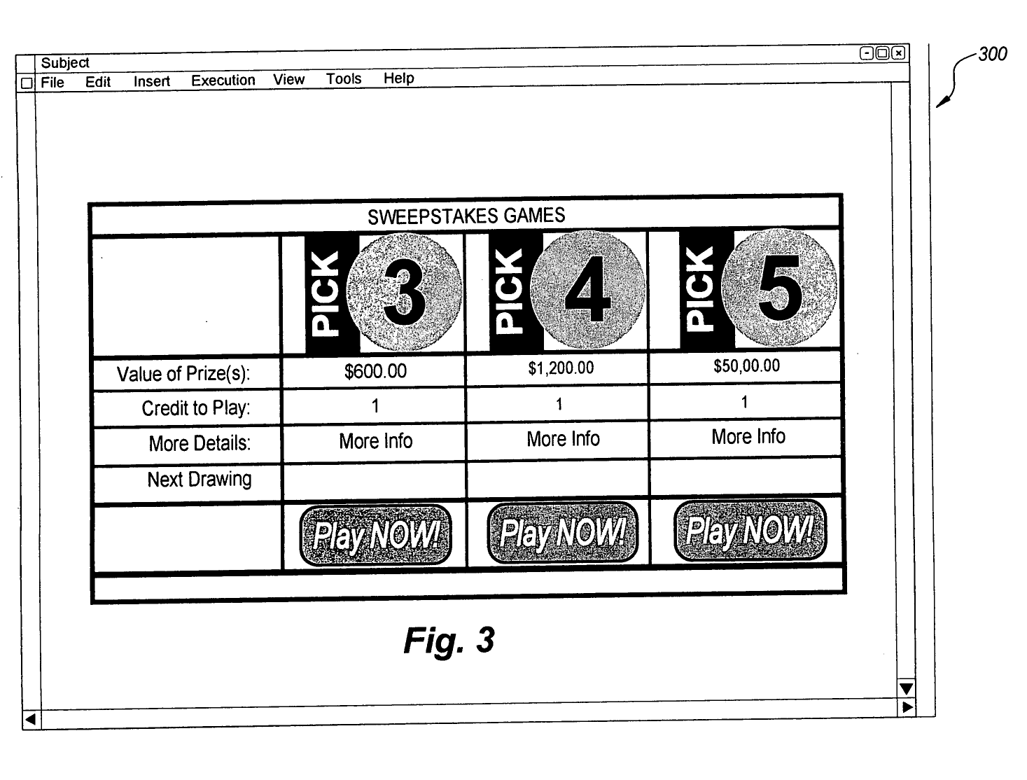

The consumer can use the issued credits to enter any of a plurality of games, such as the exemplary games 300 shown in FIG. 3. Alternatively, if the consumer wants to shop at a physical outlet, the list of participating merchants 200 provides links indicating a closest physical (“brick and mortar”) outlet to the consumer's address given to the system 10. When the consumer goes to the outlet and purchases goods or services, the merchant issues one or more identifiable scratch tickets as a function of how much the consumer has spent at the merchant's establishment. Moreover, the system 10 may provide the consumer with a stored value card, a debit card, or a credit card, which would be linked to the consumer's personal account to award credits to the consumer based on card usage.

After shopping has been completed and the consumer has received one or more scratch tickets, the consumer can again access his/her personal account and enter a promotion identifying code that is revealed when the appropriate area is scratched off each ticket. A corresponding number of electronic credits are awarded to the consumer's account.

The system 10 allows the consumer to exchange earned credits for game play, such as a lotto-type game, a multi-digit lottery game, (e.g., a three-digit, four-digit, or seven-digit lottery game), a poker game, a pai gow game, or the like. The consumer may play a currently scheduled game or choose to play a future, unscheduled game. The system 10 automatically enters the consumer in the next game when the next game's scheduling becomes known.

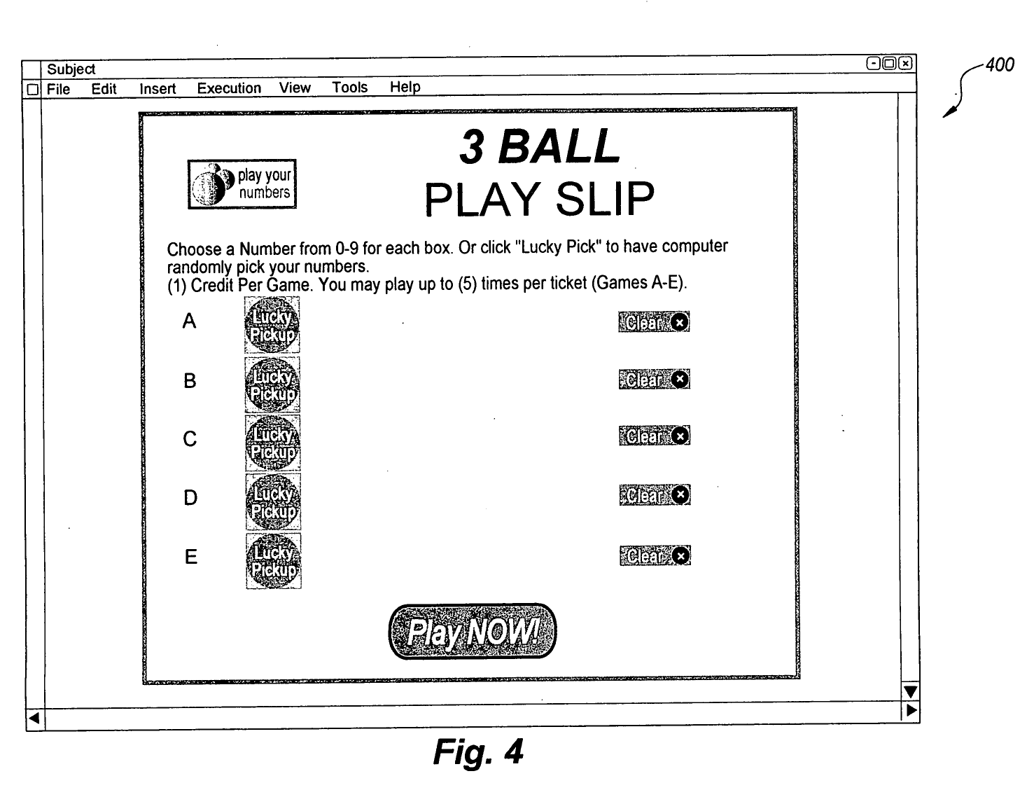

As shown in FIG. 4, the system 10 provides the consumer an electronic lottery style play slip 400 to enter the lottery sweepstakes. Web page 400 illustrates a “3 Ball” play slip, although the present invention contemplates the ability of system 10 to serve games based on any predetermined number of winning numbers, e.g., “4 Ball”, “5 Ball”, “6 Ball”, “7 Ball”, and the like. When an independent lottery drawing takes place, an administrator of system 10 can use control console 40, which is networked to the game control server on host computer 20 to enter the numbers drawn. The game control server of host computer 20 then compares the drawn numbers to the numbers selected by the consumer.

If those numbers match, the system 10 notifies the consumer via email that the consumer has won a cash or merchandise prize. On workstation 40, new games can be entered with the date the winning numbers will be chosen. The administrator can print out game results and a variety of reports on printer 50. A list of registered players can be viewed at any time. Moreover, the administrator, using admin computer 40, may specify a quantity of numbers, the numbers being used to create the scratch cards. When winning numbers are chosen, they are entered into the database of server 20, and anyone that played during a particular game will be marked as either a winner or loser. Winners will receive a notification e-mail.

One or more state lottery TV drawings can be used as the random number drawing for the lotto-type sweepstakes. The system 10 uses an independent and audited third party company to draw any lotto games being played that are not derived from a state or other independent lottery drawing. In a preferred version of the lotto game, an electronic play slip showing the logos of the participating merchants may be provided in addition to or in lieu of displaying numbers.

In this case, a table look-up is used to convert the drawn numbers entered by the site administrator into the appropriate merchant logos. If winners subsequently use their winnings from this game to purchase merchandise at the participating merchants they selected for the game, they are awarded double credits and given a cash rebate.

It is to be understood that the present invention is not limited to the embodiments described above, but encompasses any and all embodiments within the scope of the following claims.

We claim:

1. An e-commerce website method, comprising the steps of:
allowing a consumer to access the website;
providing links from the website to a plurality of merchant websites, the links being activated by consumer selection thereof;
receiving information associated with a merchant selected by the consumer, the information relating to purchases by the consumer to determine whether the consumer has made a purchase from the merchant; and, if this is the case,
issuing at least one electronic credit to the consumer for use in a prize/bonus game configured as a game having an element of chance;
conducting the game based on predetermined rules of the game; and
in the case of a win, issuing a notification to the customer entitling the consumer to a bonuses and prizes.

2. The e-commerce website method according to claim 1, wherein the credit issuing step further comprises issuing credit based on the consumer's use of a debit or credit card affiliated with the e-commerce website.

3. The e-commerce website method according to claim 1, wherein the game conducting step further comprises conducting a lottery.

4. The e-commerce website method according to claim 3, further comprising the steps of:
enforcing a predetermined game rule that the consumer must match, in exact order, numbers drawn during a drawing phase of the lottery game;
issuing to the consumer a lottery play slip having play numbers.

5. The e-commerce website method according to claim 3, further comprising the steps of:
monitoring the drawing phase of a separate, independently run lottery; and
using, in the same order, at least a subset of the resulting numbers from the independently run lottery drawing as the winning numbers in the e-commerce website lottery game.

6. The e-commerce website method according to claim 3, wherein the lottery further comprises the steps of;
allowing the consumer to select a first pattern of merchant logos within a matrix;
determining a second pattern of merchant logos within the matrix;
awarding the bonuses and prizes to the consumer when the first pattern matches the second pattern.

7. The e-commerce website method according to claim 6, wherein the second pattern-determining step further comprises using randomly generated numbers in formulating the second pattern.

8. The e-commerce website method according to claim 7, further comprising generating the random numbers in a pseudo-random manner.

9. The e-commerce website method according to claim 6, wherein the matrix represents a 2-dimensional game board.

10. The e-commerce website method according to claim 1, wherein the game=conducting step further comprises conducting a skills tournament.

11. The e-commerce website method according to claim 10, wherein the skills tournament comprises conducting a card game tournament.

12. The e-commerce website method according to claim 11, wherein the card game tournament is a blackjack tournament.

13. The e-commerce website method according to claim 11, wherein the card game tournament is a poker tournament.

14. The e-commerce website method according to claim 11, wherein the card game tournament is a pai gow tournament.

15. The e-commerce website method according to claim 1, wherein the information-receiving step further comprises accepting a scratch ticket the consumer has obtained from the merchant as proof of purchase of goods/services from the merchant.

16. The e-commerce website method according to claim 1, wherein the access-allowing step further comprises:
allowing the consumer to register into the website;
confirming the consumer registration;
informing the consumer that a predetermined electronic credit value has been earned by registering; and
welcoming the consumer to login to use the initial electronic credit and earn additional electronic credits.

17. An e-commerce website system, comprising:
means for allowing a consumer to access the e-commerce website;
means for providing links from the e-commerce website to a plurality of merchant websites, the links being activated by consumer selection thereof;
means for receiving information associated with a merchant selected by the consumer, the information relating to purchases by the consumer to determine whether the consumer has made a purchase from the merchant; and, if this is the case,
means for issuing at least one electronic credit to the consumer for use in a prize/bonus game configured as a game having an element of chance;
means for conducting the game based on predetermined rules of the game; and, in the case of a win,
means for issuing to the consumer a notification, the notification entitling the consumer to a bonus or prize.

18. The e-commerce website system according to claim 17, further comprising:
means for conducting a lottery;
means for monitoring the drawing phase of a separate, independently run lottery; and
means for using in the same order at least a subset of the resulting numbers from the independently run lottery drawing as the winning numbers in the e-commerce website lottery game.

19. A computer product comprising a medium readable by a computer, the medium having a plurality of instructions stored thereon implementing an e-commerce website, the plurality of instructions performing the steps of:
allowing a consumer to access the e-commerce website;
providing links from the e-commerce website to a plurality of merchant websites, the links being activated by consumer selection thereof;
receiving information associated with a merchant selected by the consumer, the information relating to purchases by the consumer to determine whether the consumer has made a purchase from the merchant; and, if this is the case,
issuing at least one electronic credit to the consumer for use in a prize/bonus game configured as a game having an element of chance;
conducting the game based on predetermined rules of the game; and, in the case of a win,
issuing to the consumer a notification, the notification entitling the consumer to a bonus or prize.

20. The computer product according to claim 19, the plurality of instructions further performing the steps of:
conducting a lottery game from the e-commerce website;
monitoring the drawing phase of a separate, independently run lottery; and
using in the same order at least a subset of the resulting numbers from the independently run lottery drawing as the winning numbers in the e-commerce website lottery game.
